(19) United States
(12) Patent Application Publication
(10) Pub. No.: US 2010/0042025 A1
(43) Pub. Date: Feb. 18, 2010

(54) Abdomen Massaging Apparatus

(76) Inventor: Ruei-Shan Wu, Changzhi Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/192,403

(22) Filed: Aug. 15, 2008

(51) Int. Cl. A61H 7/00

(52) U.S. Cl. 601/134; 601/87

(57) ABSTRACT

An abdomen massaging apparatus includes a gear unit, a drive motor unit, a toothed rack unit, and a sliding track unit. The toothed rack unit includes a plurality of elongated toothed racks which are arranged in a radiating manner, a plurality of roller gears each meshing with a respective one of the toothed racks and each having a central mandrel, and a plurality of rolls each mounted on the central mandrel of a respective one of the roller gears. The sliding track unit includes a successive channel to allow passage of the central mandrel of each of the roller gears. Thus, the rolls are movable along the toothed racks of the toothed rack unit reciprocally and simultaneously so as to provide a massaging effect to a user.

### BACKGROUND OF THE INVENTION

1. Field of the Invention

The present invention relates to a massaging apparatus and, more particularly, to an abdomen massaging apparatus to provide a massaging effect to a user's body, such as the user's abdomen.

2. Description of the Related Art

A conventional abdomen massaging apparatus comprises multiple rolls which are arranged in arrays, a housing for supporting the rolls, and a jacket mounted around the housing to cover the rolls. Thus, when the rolls are driven, the rolls are rolled, rotated or moved reciprocally to rub a user's body, such as the user's abdomen, so as to provide a massaging effect to the user. However, all of the rollers are moved to touch the user's body simultaneously and cannot be moved to touch the user's body in a staggered manner, so that the conventional abdomen massaging apparatus cannot simulate the kneading, grasping and pressing actions of a massager, thereby decreasing the massaging effect to the user.

### BRIEF SUMMARY OF THE INVENTION

In accordance with the present invention, there is provided an abdomen massaging apparatus, comprising a gear unit, a drive motor unit for driving the gear unit, a toothed rack unit including a plurality of elongated toothed racks which are arranged in a radiating manner, a plurality of roller gears each meshing with a respective one of the toothed racks and each having a central mandrel, and a plurality of rolls each mounted on the central mandrel of a respective one of the roller gears to move and rotate with the respective roller gear, and a sliding track unit including a successive channel to allow passage of the central mandrel of each of the roller gears.

The primary objective of the present invention is to provide an abdomen massaging apparatus, wherein the rolls are movable along the toothed racks of the toothed rack unit reciprocally and simultaneously so as to provide a massaging effect to a user.

Another objective of the present invention is to provide an abdomen massaging apparatus, wherein the rolls are movable reciprocally and rotatable along the toothed racks of the toothed rack unit, and the central roll is driven to upward and downward, so that the abdomen massaging apparatus can simulate the kneading, grasping and pressing actions of a massager, thereby enhancing the massaging effect to the user.

A further objective of the present invention is to provide an abdomen massaging apparatus, wherein the rolls are movable in a staggered manner to reach the outermost positions at different time and locations to provide a massaging effect smoothly and evenly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of an abdomen massaging apparatus in accordance with the preferred embodiment of the present invention.

FIG. 2 is a top broken view of the abdomen massaging apparatus as shown in FIG. 1.

FIG. 3 is a top view of a gear unit of the abdomen massaging apparatus as shown in FIG. 1.

FIG. 4 is a top view of a toothed rack unit of the abdomen massaging apparatus as shown in FIG. 1.

FIG. 5 is a top view of a sliding track unit of the abdomen massaging apparatus as shown in FIG. 1.

FIG. 6 is a partially top broken view of the abdomen massaging apparatus as shown in FIG. 1.

FIG. 7 is a schematic operational view of the abdomen massaging apparatus as shown in FIG. 2 in use.

FIG. 8 is a schematic operational view of the rolls of the abdomen massaging apparatus as shown in FIG. 7.

### DETAILED DESCRIPTION OF THE INVENTION

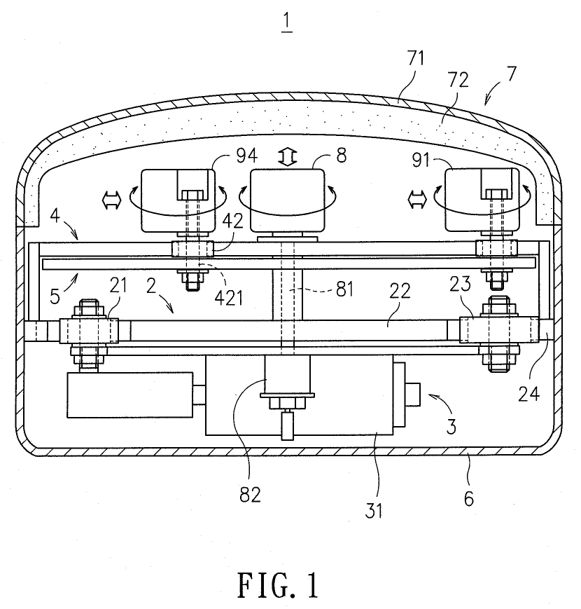

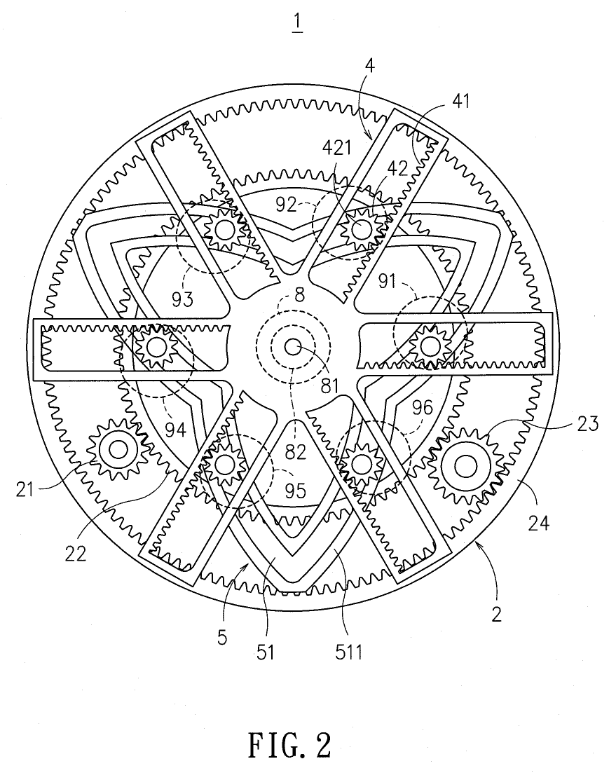

Referring to the drawings and initially to FIGS. 1 and 2, an abdomen massaging apparatus 1 in accordance with the preferred embodiment of the present invention comprises a gear unit 2, a drive motor unit 3, a toothed rack unit 4, and a sliding track unit 5.

The abdomen massaging apparatus 1 further comprises a shaft 81 pivotally mounted on a central portion of the toothed rack unit 4, a central roll 8 mounted on the shaft 81, and a magnetic switch 82 connected to the shaft 81 to drive the shaft 81 which drives the central roll 8 to move axially and reciprocally and to move upward and downward.

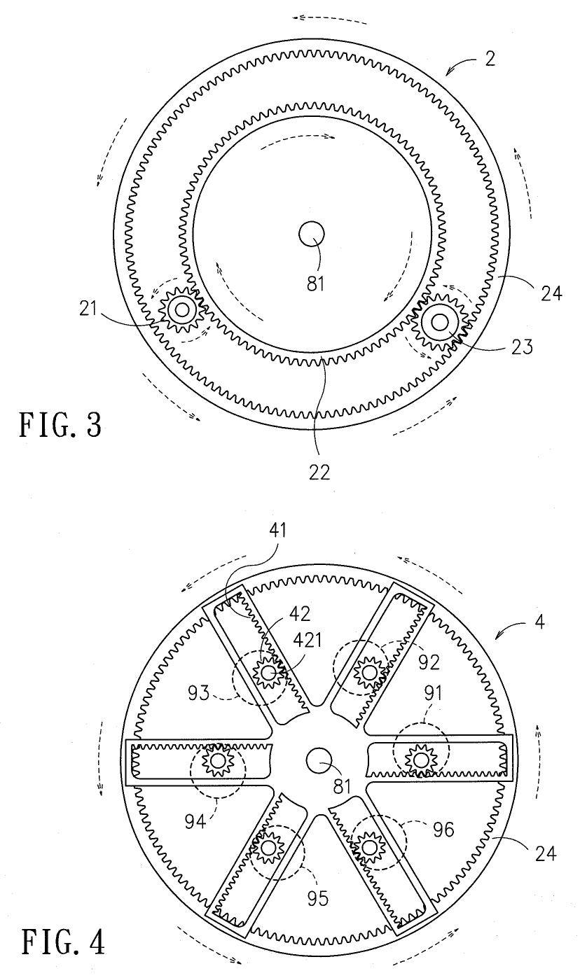

Referring to FIGS. 1-3, the gear unit 2 includes a drive gear 21, a first driven gear 22, a second driven gear 23, and a third driven gear 24. The drive gear 21 of the gear unit 2 is driven by a drive motor 31 of the drive motor unit 3. The first driven gear 22 of the gear unit 2 is an annular gear having an outer wall provided with multiple teeth. The third driven gear 24 of the gear unit 2 is an annular gear having an inner wall provided with multiple teeth. The third driven gear 24 of the gear unit 2 is located outside and surrounds the first driven gear 22 of the gear unit 2. The third driven gear 24 of the gear unit 2 is co-axial with and has a diameter greater than that of the first driven gear 22 of the gear unit 2. The drive gear 21 and the second driven gear 23 of the gear unit 2 are arranged between the first driven gear 22 and the third driven gear 24 of the gear unit 2. The drive gear 21 of the gear unit 2 meshes with the first driven gear 22 of the gear unit 2, and the second driven gear 23 of the gear unit 2 intermeshes with the first driven gear 22 and the third driven gear 24 of the gear unit 2. In such a manner, when the drive gear 21 of the gear unit 2 is driven and rotated, the drive gear 21 of the gear unit 2 in turn drives and rotates the first driven gear 22, the second driven gear 23 and the third driven gear 24 of the gear unit 2 simultaneously. The first driven gear 22 and the third driven gear 24 of the gear unit 2 are rotated in two opposite directions as shown in FIG. 3.

Referring to FIG. 1, the drive gear 21 of the gear unit 2 is driven by the drive motor 31 of the drive motor unit 3. The power of the drive motor unit 3 is supplied by a power supply (not shown) which is a direct-current or alternating-current power supply. The abdomen massaging apparatus 1 further comprises a housing 6 to receive the gear unit 2, the drive motor unit 3, the toothed rack unit 4, the sliding track unit 5 and other elements, and a protective pad 7 mounted on and enclosed around the housing 6 to provide a buffering effect to a user. The protective pad 7 includes a foam material 72 and a cloth face 71 enclosed around the foam material 72.

Referring to FIGS. 1-4, the toothed rack unit 4 includes a plurality of elongated toothed racks 41 which are arranged in a radiating manner and extend radially and outwardly, a plurality of roller gears 42 each meshing with a respective one of the toothed racks 41 and each having a central mandrel 421, and a plurality of rolls 91, 92, 93, 94, 95 and 96 each mounted on the central mandrel 421 of a respective one of the roller gears 42 to move and rotate with the respective roller gear 42. In the preferred embodiment of the present invention, the toothed rack unit 4 includes six toothed racks 41, six roller gears 42 and six rolls 91, 92, 93, 94, 95 and 96. Each of the toothed racks 41 is a hollow toothed rack, and each of the roller gears 42 is located in the respective toothed rack 41. Each of the toothed racks 41 has an inner wall provided with multiple teeth. In the preferred embodiment of the present invention, the teeth of each of the toothed racks 41 are formed on one of two opposite sides of the inner wall of each of the toothed racks 41. In practice, the toothed rack unit 4 is connected with the third driven gear 24 of the gear unit 2 so that the toothed rack unit 4 is rotated in concert with the third driven gear 24 of the gear unit 2 simultaneously.

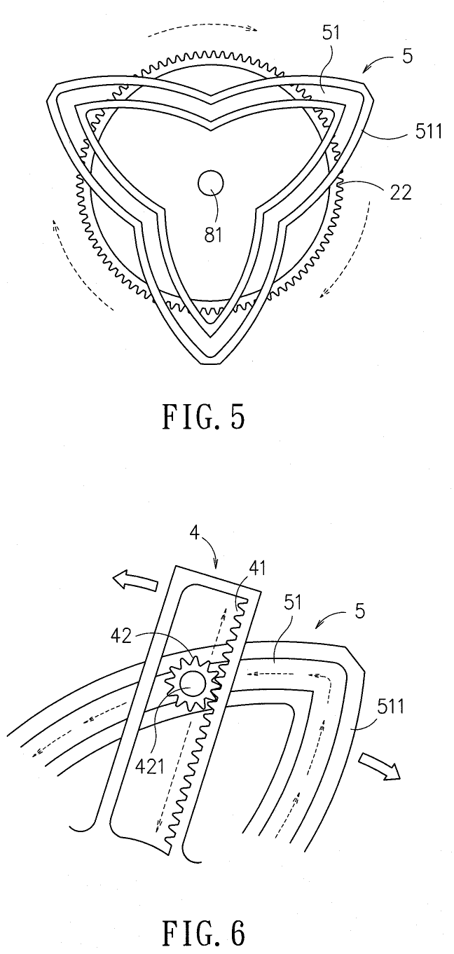

Referring to FIGS. 1-6, the sliding track unit 5 includes a successive channel 51 to allow passage of the central mandrel 421 of each of the roller gears 42. The channel 51 of the sliding track unit 5 is slidable on the central mandrel 421 of each of the roller gears 42, and the central mandrel 421 of each of the roller gears 42 is slidable in the channel 51 of the sliding track unit 5. The sliding track unit 5 includes a plurality of arc-shaped rail sets 511 which are connected with each other to form the channel 51. In the preferred embodiment of the present invention, the sliding track unit 5 includes six arc-shaped rail sets 511 which are arranged symmetrically to have a flower shape and to form the channel 51 having a symmetric arrangement. In practice, the sliding track unit 5 is connected with the first driven gear 22 of the gear unit 2 so that the toothed rack unit 4 is rotated in concert with the first driven gear 22 of the gear unit 2 simultaneously.

In operation, referring to FIGS. 2-8 with reference to FIG. 1, the first driven gear 22 and the third driven gear 24 of the gear unit 2 are rotated in two opposite directions as shown in FIG. 3, so that the sliding track unit 5 and the toothed rack unit 4 are rotated in two opposite directions as shown in FIG. 6. In such a manner, when the sliding track unit 5 and the toothed rack unit 4 are rotated simultaneously, the sliding track unit 5 and the toothed rack unit 4 produce a push force on each of the roller gears 42 to push each of the roller gears 42 toward the respective toothed rack 41. At this time, the central mandrel 421 of each of the roller gears 42 is received in the channel 51 of the sliding track unit 5, so that when the central mandrel 421 of each of the roller gears 42 is pressed by the arc-shaped rail sets 511 of the sliding track unit 5, the central mandrel 421 of each of the roller gears 42 is movable relative to the toothed rack unit 4 by guidance of the channel 51 of the sliding track unit 5, and each of the roller gears 42 is movable reciprocally on the respective toothed rack 41 of the toothed rack unit 4 as shown in FIG. 6. At the same time, when each of the roller gears 42 is moved reciprocally on the respective toothed rack 41 of the toothed rack unit 4, each of the roller gears 42 is also rotated on the respective toothed rack 41 of the toothed rack unit 4, so that the central mandrel 421 of each of the roller gears 42 is rotated, and each of the rolls 91, 92, 93, 94, 95 and 96 is also rotated.

In addition, the sliding track unit 5 includes six arc-shaped rail sets 511 which are arranged symmetrically to have a flower shape and to form the channel 51 having a symmetric arrangement, and the toothed rack unit 4 includes six toothed racks 41 which are arranged in a radiating manner, so that the roller gears 42 (and the rolls 91, 92, 93, 94, 95 and 96) are movable radially on the toothed rack unit 4 in a staggered manner and are movable toward or outwardly relative to the central portion of the toothed rack unit 4 in a staggered manner.

As shown in FIGS. 4-6, the teeth of each of the toothed racks 41 are formed on one of the two opposite sides of the inner wall of each of the toothed racks 41, so that the sliding track unit 5 has a determined rotation direction. Alternatively, if the teeth of each of the toothed racks 41 are formed on each of the two opposite sides of the inner wall of each of the toothed racks 41, the sliding track unit 5 have two opposite rotation directions.

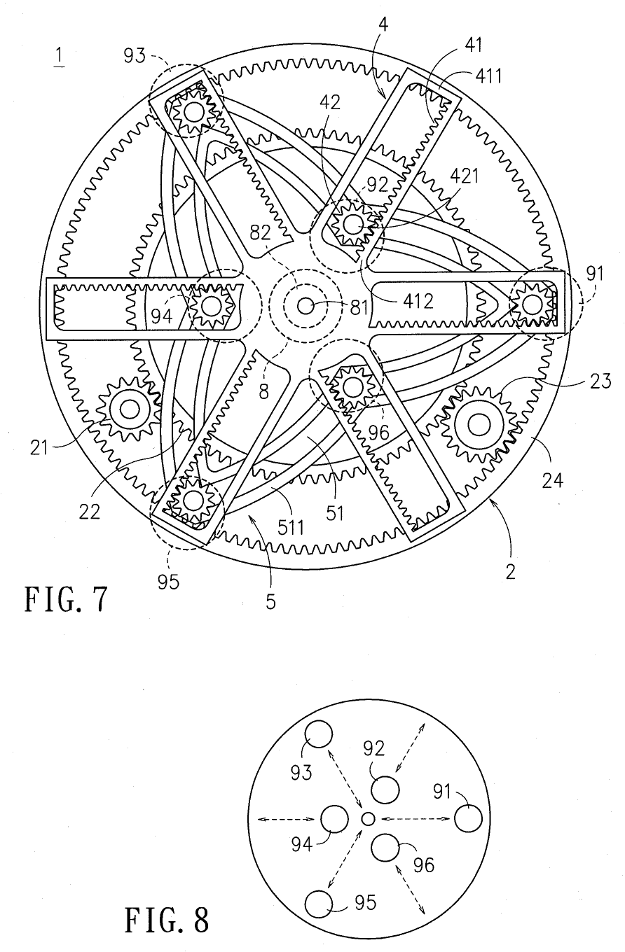

Referring to FIGS. 7 and 8, each of the odd-order rolls 91, 93 and 95 is movable to reach the outermost side of the respective toothed rack 41 and to protrude outwardly from the third driven gear 24 of the gear unit 2, and each of the even-order rolls 92, 94 and 96 is movable to reach the innermost side of the respective toothed rack 41 simultaneously. On the contrary, each of the even-order rolls 92, 94 and 96 is movable to reach the outermost side of the respective toothed rack 41 and to protrude outwardly from the third driven gear 24 of the gear unit 2, and each of the odd-order rolls 91, 93 and 95 is movable to reach the innermost side of the respective toothed rack 41 simultaneously. In such a manner, each of the odd-order rolls 91, 93 and 95 and each of the even-order rolls 92, 94 and 96 are movable to reach the outermost side of the respective toothed rack 41 at different time and locations during rotation of the sliding track unit 5 the toothed rack unit 4 to simulate the kneading, grasping and pressing actions of a massager.

Accordingly, the rolls 91, 92, 93, 94, 95 and 96 are movable along the toothed racks 41 of the toothed rack unit 4 reciprocally and simultaneously to provide a massaging effect to a user. In addition, the rolls 91, 92, 93, 94, 95 and 96 are movable reciprocally and rotatable along the toothed racks 41 of the toothed rack unit 4, and the central roll 8 is driven to upward and downward, so that the abdomen massaging apparatus can simulate the kneading, grasping and pressing actions of a massager, thereby enhancing the massaging effect to the user. Further, the rolls 91, 92, 93, 94, 95 and 96 are movable in a staggered manner to reach the outermost positions at different time and locations to provide a massaging effect smoothly and evenly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An abdomen massaging apparatus, comprising:
a gear unit;
a drive motor unit for driving the gear unit;
a toothed rack unit including a plurality of elongated toothed racks which are arranged in a radiating manner, a plurality of roller gears each meshing with a respective one of the toothed racks and each having a central mandrel, and a plurality of rolls each mounted on the central mandrel of a respective one of the roller gears to move and rotate with the respective roller gear;
a sliding track unit including a successive channel to allow passage of the central mandrel of each of the roller gears.

2. The abdomen massaging apparatus of claim 1, wherein
the toothed rack unit and the sliding track unit are driven by the gear unit and are rotatable in two opposite directions;
the central mandrel of each of the roller gears is movable in the channel of the sliding track unit;
each of the roller gears is movable reciprocally on the respective toothed rack;
the rolls are movable radially on the toothed rack unit in a staggered manner and are movable toward or outwardly relative to a central portion of the toothed rack unit in a staggered manner.

3. The abdomen massaging apparatus of claim 2, wherein
the gear unit includes:
a drive gear;
a first driven gear meshing with and driven by the drive gear;
a second driven gear meshing with and driven by the first driven gear;
a third driven gear meshing with and driven by the second driven gear;
the third driven gear of the gear unit is co-axial with the first driven gear of the gear unit;
the first driven gear and the third driven gear of the gear unit are rotated in two opposite directions;
the toothed rack unit is connected with the third driven gear of the gear unit so that the toothed rack unit is rotated in concert with the third driven gear of the gear unit simultaneously;
the sliding track unit is connected with the first driven gear of the gear unit so that the toothed rack unit is rotated in concert with the first driven gear of the gear unit simultaneously.

4. The abdomen massaging apparatus of claim 3, wherein the drive gear of the gear unit is driven by a drive motor of the drive motor unit.

5. The abdomen massaging apparatus of claim 3, wherein
the first driven gear of the gear unit is an annular gear having an outer wall provided with multiple teeth;
the third driven gear of the gear unit is an annular gear having an inner wall provided with multiple teeth;
the third driven gear of the gear unit is located outside and surrounds the first driven gear of the gear unit;
the third driven gear of the gear unit has a diameter greater than that of the first driven gear of the gear unit;
the drive gear and the second driven gear of the gear unit are arranged between the first driven gear and the third driven gear of the gear unit;
the drive gear of the gear unit meshes with the first driven gear of the gear unit;
the second driven gear of the gear unit intermeshes with the first driven gear and the third driven gear of the gear unit.

6. The abdomen massaging apparatus of claim 1, further comprising:
a shaft 81 pivotally mounted on a central portion of the toothed rack unit;
a central roll mounted on the shaft;
a magnetic switch connected to the shaft to drive the shaft which drives the central roll to move axially and reciprocally.

7. The abdomen massaging apparatus of claim 1, further comprising:
a housing to receive the gear unit, the drive motor unit 3, the toothed rack unit and the sliding track unit.

8. The abdomen massaging apparatus of claim 1, further comprising:
a protective pad mounted on and enclosed around the housing;
wherein the protective pad includes a foam material and a cloth face enclosed around the foam material.

9. The abdomen massaging apparatus of claim 1, wherein the toothed rack unit includes six toothed racks, six roller gears and six rolls.

10. The abdomen massaging apparatus of claim 9, wherein the sliding track unit includes a plurality of arc-shaped rail sets which are connected with each other to form the channel.

11. The abdomen massaging apparatus of claim 10, wherein the sliding track unit includes six arc-shaped rail sets which are arranged symmetrically to have a flower shape and to form the channel having a symmetric arrangement.

12. The abdomen massaging apparatus of claim 2, wherein the roller gears are movable radially on the toothed rack unit in a staggered manner and are movable toward or outwardly relative to a central portion of the toothed rack unit in a staggered manner.

13. The abdomen massaging apparatus of claim 1, wherein
each of the toothed racks is a hollow toothed rack;
each of the roller gears is located in the respective toothed rack.

14. The abdomen massaging apparatus of claim 13, wherein each of the toothed racks 41 has an inner wall provided with multiple teeth.

15. The abdomen massaging apparatus of claim 14, wherein the teeth of each of the toothed racks are formed on one of two opposite sides of the inner wall of each of the toothed racks.

16. The abdomen massaging apparatus of claim 10, wherein
the channel of the sliding track unit is slidable on the central mandrel of each of the roller gears;
the central mandrel of each of the roller gears is slidable in the channel of the sliding track unit.

17. The abdomen massaging apparatus of claim 16, wherein
when the central mandrel of each of the roller gears is pressed by the arc-shaped rail sets of the sliding track unit, the central mandrel of each of the roller gears is movable relative to the toothed rack unit by guidance of the channel of the sliding track unit, and each of the roller gears is movable reciprocally on the respective toothed rack of the toothed rack unit;
when each of the roller gears is moved reciprocally on the respective toothed rack of the toothed rack unit, each of the roller gears is rotated on the respective toothed rack of the toothed rack unit, so that the central mandrel of each of the roller gears is rotated, and each of the rolls is rotated.

18. The abdomen massaging apparatus of claim 1, wherein each of the rolls is movable to reach an outermost side of the respective toothed rack in a staggered manner and to protrude outwardly from the third driven gear of the gear unit.
